(19) United States
(12) Patent Application Publication
(10) Pub. No.: US 2021/0331639 A1
(43) Pub. Date: Oct. 28, 2021

(54) INTEGRATED BATTERY BOOSTER FOR A VEHICLE AND METHOD

(71) Applicant: EZBOOSTR INC., Beaconsfield (CA)

(72) Inventors: Richard VALDEVIT, Laval (CA); Antonio MANCINI, Laval (CA); Gary TABAH, Town of Mont-Royal (CA); Vince MERCURIO, Beaconsfield (CA)

(21) Appl. No.: 17/273,843

(22) PCT Filed: Sep. 5, 2019
(86) PCT No.: PCT/CA2019/000125

§ 371 Date: Mar. 5, 2021

Related U.S. Application Data
(60) Provisional application No. 62/727,346, filed on Sep. 5, 2018.

(51) Int. Cl. B60R 16/033

(52) U.S. Cl. CPC B60R 16/033

(57) ABSTRACT

A device for providing additional electrical power to an engine powered vehicle comprising a vehicle battery and an alternator, the device comprises an auxiliary battery. The auxiliary battery is installed within or mounted to the vehicle and maintained therein during driving of the vehicle. Electrical communication between the auxiliary battery and the vehicle battery is provided. The auxiliary battery provides for supplying additional electrical power for starting the engine when the vehicle battery is depleted and/or for recharging the vehicle battery to avoid depletion thereof.

### CROSS-REFERENCE TO RELATED APPLICATIONS

The present application claims priority on U.S. Provisional Patent Application Ser. No. 62/727,346 filed on Sep. 5, 2018 and incorporated herein in its entirety.

### TECHNICAL FIELD

The present disclosure generally relates boosting or jump-starting vehicles. More particularly but not exclusively the present disclosure relates to an integrated battery booster device for a vehicle and method. More specifically but still not exclusively, the present disclosure relates to a device for providing additional electrical power to an engine powered vehicle as well as a system and method therefor.

### BACKGROUND

A jump start, also called a boost, is a method of starting a vehicle with a discharged or dead battery. A temporary connection is made to another external power source. The external supply of electricity recharges the disabled vehicle's battery and provides some of the power needed to crank the engine. Once the vehicle has been started, its normal charging system will recharge, so the auxiliary source can be removed. AC battery chargers have a boost, engine start, or engine assist feature. Battery boosters or jump starters are portable battery devices that allow for jump starting of vehicles. These devices operate similar to jumper cables but do not require an additional vehicle to provide the power needed to boost the dead vehicle battery. Usually, drivers must attempt to start their vehicle in order to realize that their battery has died at which time, they can use their own portable battery booster or call for road assistance.

### Objects

An object of the present disclosure is to provide a device for providing additional electrical power to an engine powered vehicle.

An object of the present disclosure is to provide a system for monitoring a plurality of the devices for providing additional electrical power to an engine powered vehicle.

An object of the present disclosure is to provide a method for providing additional electrical power to an engine powered vehicle

### SUMMARY

In accordance with an aspect of the present disclosure, there is provided a device for providing additional electrical power to an engine powered vehicle comprising a vehicle battery and an alternator, the device comprising: an auxiliary battery for being mounted to the vehicle to be maintained therewith during driving of the vehicle, the auxiliary battery being positioned and maintained in electrical communication with the vehicle battery during driving of the vehicle, wherein the auxiliary battery provides for supplying additional electrical power for starting the engine when the vehicle battery is depleted and/or for recharging the vehicle battery to avoid depletion thereof.

In an embodiment, the auxiliary battery is positioned within the vehicle and maintained within the vehicle.

In an embodiment, the device further comprises a cable in electrical communication with the auxiliary battery for being positioned and maintained in electrical communication with the vehicle battery during driving of the vehicle to provide the electrical communication between the auxiliary battery and the vehicle batter. In an embodiment, the cable is positioned and maintained in electrical communication with the alternator to receive electrical power therefrom during driving of the vehicle for recharging thereof. In an embodiment, the cable is in electrical communication with the alternator via a ground connection. In an embodiment, the ground connection is provided by a removable fastener. In an embodiment, the cable is fastened to the vehicle battery.

In an embodiment, the vehicle battery provides for replenishing the auxiliary battery with electrical power during driving of the vehicle.

In an embodiment, the device further comprises a housing for housing the auxiliary battery therein. In an embodiment, the housing comprises a connector for providing electrical communication with the auxiliary battery. In an embodiment, the housing comprises water-resistant material.

In an embodiment, the device further comprises a heating element in communication with the auxiliary battery for heating thereof, a heating element controller in communication with the heating element for control thereof and an ambient temperature sensor for detecting the ambient temperature and being in communication with the heating element controller, the heating element controller providing for modulating the heating element to selectively provide heat to the auxiliary battery based on the detected ambient temperature.

In an embodiment, the device further comprises a controller comprising a processor and an associated memory of processor executable code that when executed provides the controller to perform computer implementable steps, the controller being in communication with the auxiliary battery; and a user interface in communication with the controller.

In an embodiment, the controller is in operative communication with the auxiliary battery, the user interface providing a user to selectively modulate electrical power supply from the auxiliary battery via commands transmitted to the controller.

In an embodiment, the controller performs the computer implementable steps of: identifying a real-time amount of electrical power stored in the auxiliary battery; and communicating the real-time amount of electrical power stored to a user via the user interface. In an embodiment, the device further comprises an auxiliary battery sensor in communication with the auxiliary battery and the controller for detecting the real-time amount of electrical power stored in the auxiliary battery and for transmitting the detected amount to the controller.

In an embodiment, the controller performs the computer implementable steps of: identifying a condition status of the auxiliary battery; and communicating the condition status of the auxiliary battery to the user via the user interface.

In an embodiment, the controller is positioned in and configured for operative communication with the vehicle battery. In an embodiment, the controller performs the computer implementable steps of: identifying the amount of electrical power stored in the vehicle battery; communicating the real-time amount of electrical power stored to a user via the user interface. In an embodiment, the device further comprises a vehicle battery sensor in communication with the vehicle battery and the controller for detecting the real-time amount of electrical power stored in the vehicle battery and for transmitting the detected amount to the controller.

In an embodiment, the controller performs the computer implementable steps of: identifying a condition status of the vehicle battery; and communicating the condition status of the vehicle battery to the user via the user interface.

In an embodiment, the device further comprises an ambient temperature sensor in communication with the controller for detecting the ambient temperature and transmitting the detected ambient temperature to the controller. In an embodiment, the device further comprises a heating element in operational communication with the auxiliary battery for providing heating thereto and in operational communication with the controller, the controller performing the computer implementable step of: modulating the heating element to selectively provide heat to the auxiliary battery based on the ambient temperature.

In an embodiment, the controller performs the computer implementable step of: communicating the ambient temperature to the user via the user interface. In an embodiment, the device further comprises a heating element in operational communication with the auxiliary battery for providing heating thereto and in operational communication with the controller, wherein the controller performs the computer implementable step of: communicating the ambient temperature to the user via the user interface for providing the user to selectively modulate the heating element to selectively provide heat to the auxiliary battery via the controller by way of user commands.

In an embodiment, the device further comprises an additional condition detecting instrument for detecting a pre-determined condition, the additional condition detecting instrument being in operational communication with the controller for providing thereto the detected condition. In an embodiment, the controller communicates the detected condition to the user via the user interface.

In an embodiment, the additional condition detecting instrument is selected from the group consisting of a motion detector, a GPS, an ambient sound detector, a data input for a vehicle integrated computer, a moisture sensor and any combination thereof.

In an embodiment, the controller and user interface are integrated in a handheld mobile unit.

In an embodiment, the controller is positioned within the vehicle and the user interface being integrated into a remote device.

In an embodiment, the controller comprises an assembly, the assembly comprising a plurality of processors, one processor being positioned within the vehicle another processor being integrated into a remote device. In an embodiment, the user interface is integrated into the remote device. In an embodiment, the remote device comprises a handheld unit.

In an embodiment, the device further comprises at least one supplemental instrument in operative communication with an element selected from the group consisting of: the auxiliary battery, the vehicle battery, the alternator, a vehicle computer, one or more vehicle components and any combination thereof. In an embodiment, the controller is in operative communication with the element and performs the computer implementable step of: modulating the element in accordance with a status condition.

In accordance with an aspect of the present disclosure, there is provided a method for providing additional electrical power to an engine powered vehicle comprising a vehicle battery and an alternator, the method comprising: installing an auxiliary battery within the vehicle to be maintained therein during driving of the vehicle; providing electrical communication between the auxiliary battery and the vehicle battery during driving of the vehicle, supplying additional electrical power from the auxiliary batter for starting the engine when the vehicle battery is depleted and/or for recharging the vehicle battery to avoid depletion.

In an embodiment, the method further comprises: replenishing the auxiliary battery with electrical power from the alternator when driving the car and or from the vehicle battery when driving the car.

In an embodiment, the method further comprises: detecting a real-time condition status of the auxiliary battery and/or the vehicle and communicating the real-time condition to a remote user in real-time.

In an embodiment, the method further comprises modulating heating of the auxiliary battery based on ambient temperature.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic representation of the device for providing additional electrical power to an engine powered vehicle in accordance with a non-restrictive illustrative embodiment of the present disclosure;

FIG. 2 is a front and top perspective view of the device for providing additional electrical power to an engine powered vehicle in accordance with another non-restrictive illustrative embodiment of the present disclosure;

FIG. 3 is a lateral and top perspective view of the device of FIG. 2;

FIG. 4 is an exploded perspective view of the device of FIG. 2;

FIG. 5 is a schematic representation of the cable connector of the device of FIG. 2;

FIGS. 6A, 6B and 6C top and side perspective view of the device of FIG. 2 being installed in a vehicle;

FIG. 7 is a schematic representation of the circuit board of the device of FIG. 2; and

FIG. 8 is schematic representation of a system for monitoring and/or modulating one or more devices for providing additional electrical power to an engine powered vehicle in accordance with a non-restrictive illustrative embodiment of the present disclosure.

### DETAILED DESCRIPTION OF ILLUSTRATIVE EMBODIMENTS

Generally stated and in accordance with an aspect of the present disclosure, there is provided a device for providing additional electrical power to an engine powered vehicle comprising a vehicle battery and an alternator, the device comprises an auxiliary battery and a cable. The auxiliary battery is installed within the vehicle and maintained therein during driving of the vehicle. The cable is in electrical communication with the auxiliary battery and is positioned and maintained in electrical communication with the vehicle battery during driving of the vehicle to provide electrical communication between the auxiliary battery and the vehicle battery. The auxiliary battery provides for supplying additional electrical power for starting the engine when the vehicle battery is depleted and/or for recharging the vehicle battery to avoid depletion thereof.

In an embodiment, the device of the present disclosure provides an auxiliary for an engine powered vehicle, to be used if the vehicle battery is depleted due to user error, environmental conditions, electrical faults, and the like. In an embodiment, the device is a battery booster providing a temporary source of additional electrical power to allow starting the engine of the vehicle, at which point the vehicle battery can be re-charged via the normal operation of the alternator. In an embodiment, the device of the disclosure is installed inside the engine compartment of the vehicle. In an embodiment, once installed, the device requires no further assembly or installation to provide the additional boost power to the vehicle upon request. In an embodiment, the device recharges automatically when the alternator of the vehicle and can be operated either via direct manual control (i.e. buttons and indicators on the case) or remotely via radio-frequency using a device such as a mobile phone, tablet, or a purpose-built remote control unit.

In an embodiment, the disclosure provides a removably integrated battery booster for land and/or marine vehicles. In an embodiment, the disclosure provides a ‘smart’ battery booster for land and/or marine vehicles comprising sensors and a controller for communicating and/or modulating a condition a condition as will be disclosed herein.

With respect to the Figures, non-limiting illustrative embodiments of the present disclosure will be described.

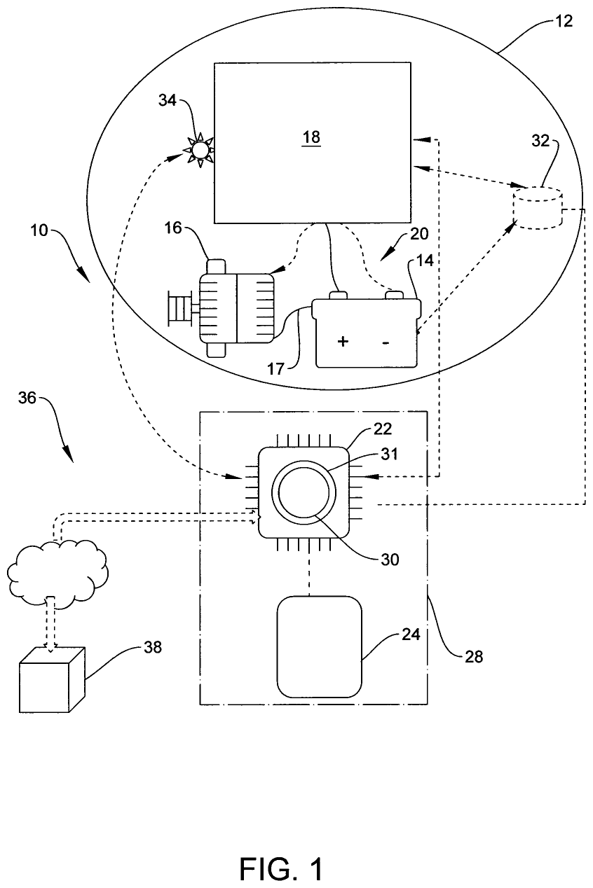

FIG. 1 is a schematic representation of the device 10 for providing additional electrical power to an engine powered vehicle 12. The vehicle 12 comprises a vehicle battery 14 and an alternator 16 which is in electrical communication 17 with the vehicle battery. The device 10 comprises an auxiliary battery 18 and a cable 20 both of which are installed within the vehicle.

As shown, the cable 20 provides for electrical communication between the auxiliary battery 18 and the vehicle battery 14. In an embodiment, the cable 20 provides electrical communication between the auxiliary battery 18 with the positive and negative poles of the vehicle battery 14. In an embodiment, the cable 20 provides electrical communication between the auxiliary battery 18 and the positive pole of the vehicle battery 14 and electrical communication between the auxiliary battery 18 and the alternator 16 via a ground connection.

The auxiliary battery 18 is in operative communication with a controller 22 which is in operative communication with a user interface 24 (the controller 22 being configured for such operative communication with the auxiliary battery 18 and with the interface 24). In an embodiment, the controller 22 is mounted directly within the vehicle 12. In an embodiment, the controller 22 communicates remotely with the auxiliary battery 18 and/or vehicle battery 18. In an embodiment, the controller 22 comprises a controller assembly (i.e. an assembly of multiple controllers). In an embodiment, the controller assembly 22 comprises one controller mounted within the vehicle 12 or the device 10 and another controller being remote. In an embodiment, the controller 22 and the interface 24 are integrated within a mobile handheld unit 28 and as such, the user interface 24 comprises a display and user controls. In an embodiment, the controller 22 is a system controller mounted within device 10 and the user interface 24 comprises a physical user interface the controller 22 communicates with the user via a remote interface (e.g. a mobile unit display) also forming part of the user interface 24. The foregoing may be provided by way of the controller 22 communicating with the processor of the mobile unit. In an embodiment, this processor forms part of the controller 22 (which is considered an assembly of controllers in this case).

As shown, the controller 22 comprises a processor (or microprocessor) 31 with an associated memory 30 of processor executable code that when executed provide the controller of performing computer implementable steps of assessing a condition status of the auxiliary battery 14 and/or the vehicle battery 18. In an embodiment, the controller 22 is configured for and placed in operative communication with the vehicle integrated computer to assess a condition status of the vehicle and components thereof. Accordingly, execution of the processor executable code in the memory 30 provides for the controller 22 to perform a computer implementable step of communicating a condition status as defined herein to a user via the interface 24.

In an embodiment, the controller 22 is configured for and in operative communication with the auxiliary battery 18 and/or the vehicle battery 14 and execution of the processor executable code in the memory 30 provides for the controller 22 to perform a computer implementable step of modulating the auxiliary battery 18 and/or the vehicle battery 14. For example, the auxiliary battery 18 and the vehicle battery 14 may be modulated for reciprocal recharging thereof.

In an embodiment, one or more sensors 32 are in operative communication with the controller 22 (configured for such operative communication) for transmitting a detected condition status thereto. The one or more sensors 32 include without limitation an auxiliary battery sensor for detecting the electrical power level stored in the auxiliary battery 18, a battery sensor for detecting the electrical power level stored in the auxiliary battery 18, and additional condition detecting instrument is selected from the group consisting of a motion detector, a GPS, an ambient sound detector, a data input for a vehicle integrated computer, a moisture sensor and the like and any combination thereof.

In an embodiment, execution of the processor executable code within the memory 30 provides the controller 22 to perform the computer implementable step of assessing the detected condition status and to perform additional computer implementable steps in response thereto such as modulating the auxiliary battery 18 and/or vehicle batter 14 directly or via a supplemental instrument 34 and/or communicating the condition status to the user via the user interface 24 thereby allowing the user to modulate the batteries 18 and/or 14 directly or via a supplemental instrument 34 by way of sending commands to the controller 22 through the user interface 24.

In an embodiment, the supplemental instrument 34 comprises a heating element which is in operative communication with the auxiliary battery 18 and/or the vehicle battery 14 for heating thereof based on a predetermined temperature condition status included within the memory 30 of the controller 22. In an embodiment, the temperature condition status comprises the ambient temperature and as detected by an ambient temperature sensor 32.

In an embodiment, the present disclosure provides a system 36 for monitoring a plurality of the devices 10. Accordingly, the controller 22 is in operative communication with a remote master controller 38 for transmitting assessed information in order to provide monitoring by a system monitor via a system interface.

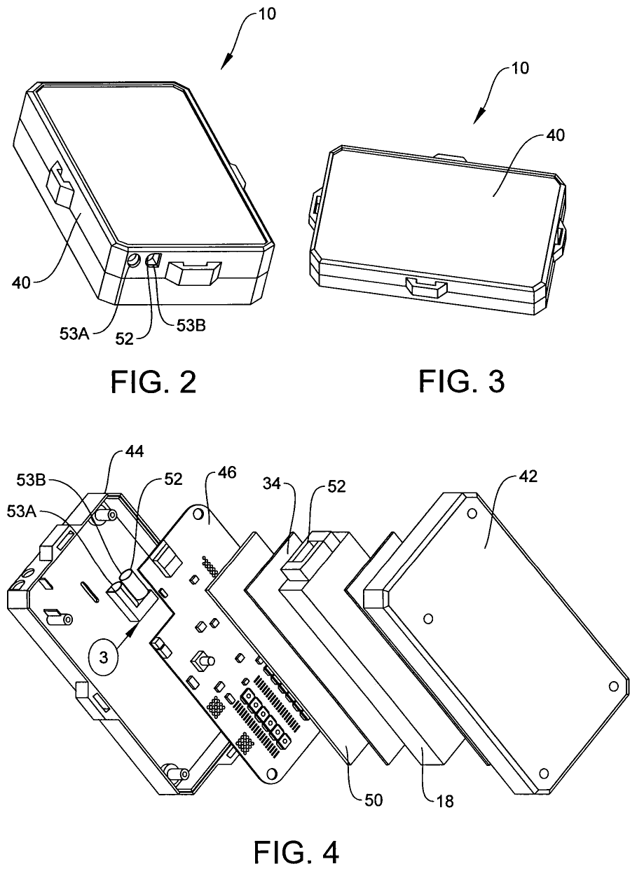

Turning to FIGS. 2 to 4, the device 10 comprises a housing 40 including a bottom chassis 42 and a top chassis 44 enclosing the auxiliary battery 18, a circuit board 46, a heating element (in the form of a plate) 34 and a sticky pad 50 therein. The skilled artisan will readily appreciate that in another embodiment, the sticky pad 50 may not be included. The auxiliary battery 18 includes a connector 52 for removably mounting the cable 20 thereto. The circuit board 46 comprises the controller 22 and the memory 30. The controller 22 comprises the processor (or microprocessor) 31.

In an embodiment, the housing 40 is made of water resistant material and the vehicle 12 comprises a power boat or another marine type vehicle.

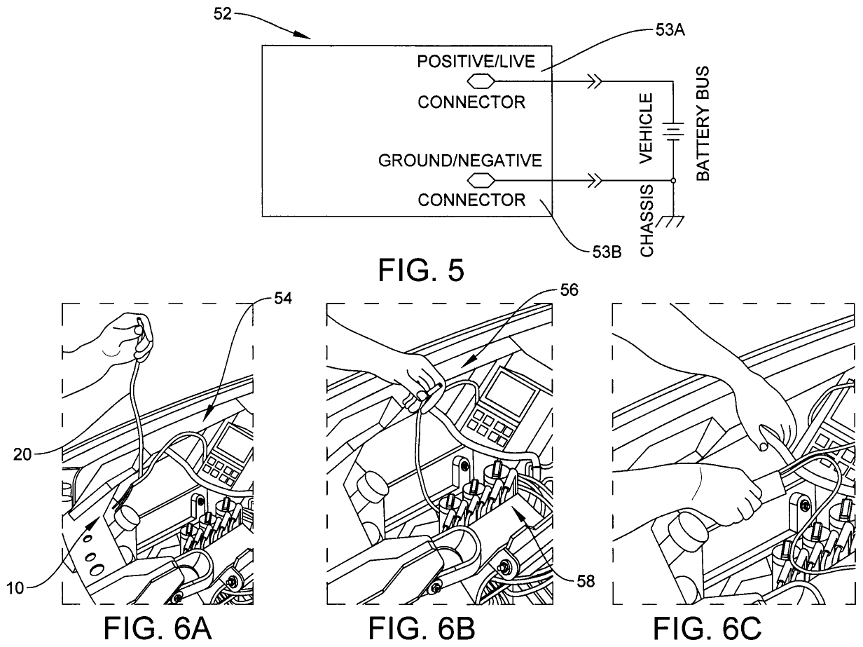

With reference to FIGS. 2, 4 and particular reference to FIG. 5, the connector 52 includes a positive/live connector (53A) and a ground/negative connector (53B).

With reference to FIGS. 6A to 6C, a user is shown positioning a device 10 within the engine compartment 54 of the vehicle 12. The user connects the cable 20 to a car booster connection 56 and then connects the cable 20 to the ground 58 of the vehicle 12. As shown, the user fastens the cable 20 to connection 56 and ground 58.

In the event that the user wishes to boost a vehicle other than the one the device 10 was originally installed in, it can also be detached from the original vehicle and combined with a compatible (optional) set of clamp connectors, which allow it to be used in a manner similar to a regular portable boost device. It can also be charged outside the vehicle using an optional AC-to-DC converter, which operates using a standard wall plug arrangement.

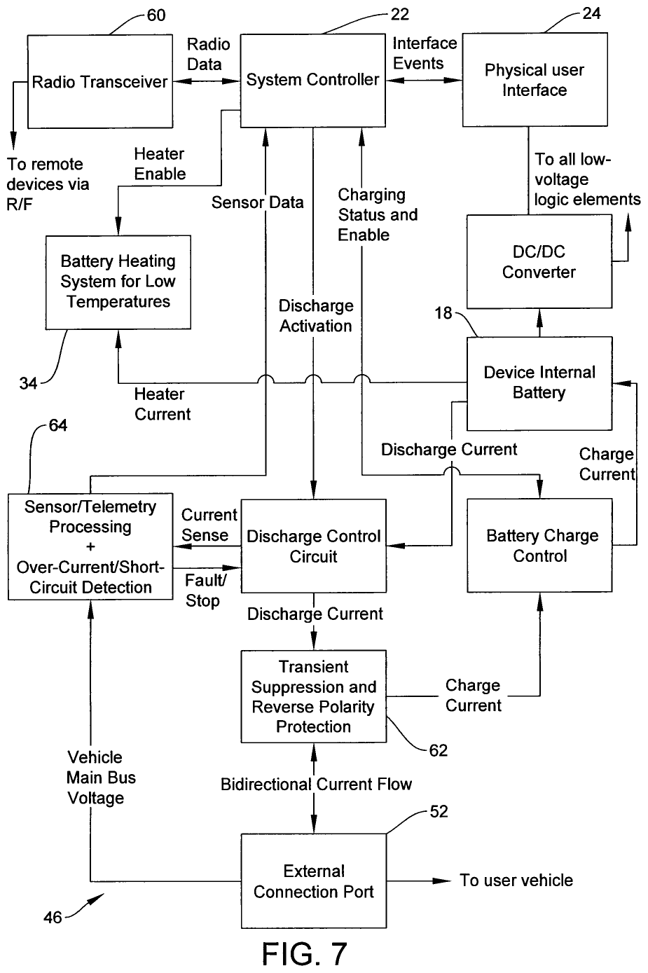

With reference to FIG. 7, the circuit board 46 will now be described in accordance with a non-limiting illustrative embodiment of the present disclosure.

The circuit board 46 includes a system controller 22 in communication with a Radio transceiver 60 which is communication with remote devices via radiofrequency communication. The device 10 also supports the Bluetooth Low Energy protocol and can be paired to multiple user Bluetooth host devices such as mobile phones, tablets, and purpose-built remote control units. The device 10 can both receive instructions from the host device (such as to initiate the boost process) and transmit status information back to the host for e.g. presentation to the user, telemetry logging and analysis, troubleshooting, warning of abnormal states, etc.

The device 10 comprises a physical user interface 24.

The device 10 includes a number of non-limiting safety systems to prevent harmful failure conditions that would damage the device 10 or the attached vehicle 12.

In an embodiment, the device 10 comprises a transient voltage suppression 62 to suppress unexpectedly high voltage “spikes” caused by anomalous events within the vehicle's electrical system. Accordingly, voltage excursions that reach the device 10 are dissipated harmlessly within the protection circuitry.

In an embodiment, the device 10 comprises an abnormal current level protection, which will cause the boost process to automatically take measures if abnormal current flow into the vehicle 12 is detected. In an embodiment, the protection system has four mechanisms of operation, namely a short-circuit protection, an over-current protection, anomalous current patterns detector, and a fail-safe protection. The foregoing will be further described in accordance with non-limiting embodiments thereof.

Short-circuit protection 64: in the event that a current vastly beyond normal specifications is detected, the controller 22 treats the situation as a short circuit and immediately disables the boost. In one non-limiting embodiment, to ensure maximum response speed and reliability, this is handled directly at the hardware level in.

Over-current protection 64: in the event that an abnormally high, but not extreme, current is detected for an extended period of time, the controller 22 initiates a delayed shutdown of the boost process. If the current returns to normal levels within a short time period, the process continues as normal. To ensure maximum reliability, this is also handled directly at the hardware level.

Anomalous current patterns: the controller 22 monitors the instantaneous current at any point in time and detects abnormal current consumption that indicates a problem with the vehicle's electrical system. The controller 22 then indicates to the user via the interface 24 that this condition is present and adjusts its behavior accordingly.

Fail-safe protection: the device 10 is equipped with specialized high-current automotive fuses on both its internal battery 18 connection and the external connection to the vehicle, as well as smaller fuses protecting various low-power circuitry such as the charging system and logic controllers. In the event that a short circuit or extreme voltage excursion occurs despite all other protection measures (due to physical damage, component defects, a fault in the vehicle's electrical system, etc.), the fuses will act as a last line of defense to mitigate any damage that would otherwise have occurred.

In an embodiment, the device 10 comprises reverse polarity protection 62, which protects the device's internal battery 18 from uncontrolled back-flow current originating from the vehicle 12. This ensures that current only flows into the internal battery 18 via the appropriate pathways in the charge control system 66, and appropriate current and voltage limits are respected.

In an embodiment, the device 10 uses a diode-free reverse polarity protection system 62. Although diode-based systems achieve a similar objective, they dissipate considerable power during normal “forward” (boost) discharges as heat. Consequently, the diodes are a remarkably common point of failure for devices that use them (due to overheating). In addition, the power wasted as heat is unavailable to the vehicle 12 as part of the boost process, reducing the effectiveness of the device 10.

In an embodiment, the device 10 comprises over-temperature protection, which provides the controller 22 to perform the step of preventing or abort the boost process in the event that the device's temperature exceeds safe limits (either due to environmental factors, or excessive heating of internal electronics).

In an embodiment, the device 10 comprises an internal cell balance protection system, which allows for automatic balancing of cell voltages for batteries with multi-cell configurations to prevent premature failure of the battery due to uneven charging of the cells.

In an embodiment, the device 10 provides for cold-weather mitigation. Batteries offering high discharge current typically have vastly reduced performance at cold temperatures. The device 10 includes an internal system of heating elements 34 within silicone pads to allow it to pre-heat its internal battery 18, as well as temperature sensors 32 to ensure that the battery 18 has reached an appropriate temperature range before the boost process proceeds.

The device 10 has the ability to transmit telemetry data to a remote device via radio frequency, as such, the device 10 provides a considerable degree of extensibility, as the software on the user device can perform a variety of analysis and processing of the data to identify patterns beyond the boost process itself. This allow the user to, automatically receive a warning that the vehicle's main battery 14 is draining at an abnormally high rate, or that the vehicle's alternator 16 voltage is outside the normal operating range.

The device 10 is mountable to a wide variety of vehicles, and offers a number of mounting options. It can be tied down directly to the vehicle's battery 14, or attached to most flat surfaces within the engine compartment. It can also be optionally enclosed in a secondary fabric case for additional protection against dirt and contaminants, further extending the number of mounting options.

In one example, the controller 22 performs the step of informing the user via the interface 24 that their vehicle battery 14 is depleted and moreover that the ambient temperature is extremely low rendering the auxiliary battery 18 ineffective. The controller 22 further informs the user that it will heat the auxiliary battery 18 via the heating plate 34 to rectify its condition status. The user is then notified that the boosting process can be executed and as such may start the engine normally (using the key, push-button etc.) once the boost process is complete. In another embodiment, the user may remotely start the engine via the interface 24 with the device 10 providing the additional electric power required. As the car alternator 16 runs, the vehicle battery 14 is recharged. The device 10 communicates with the master controller 38 which assesses an issue with the vehicle battery type due to a large number of similar instances and provides a report to a plurality of users via the user interface 24.

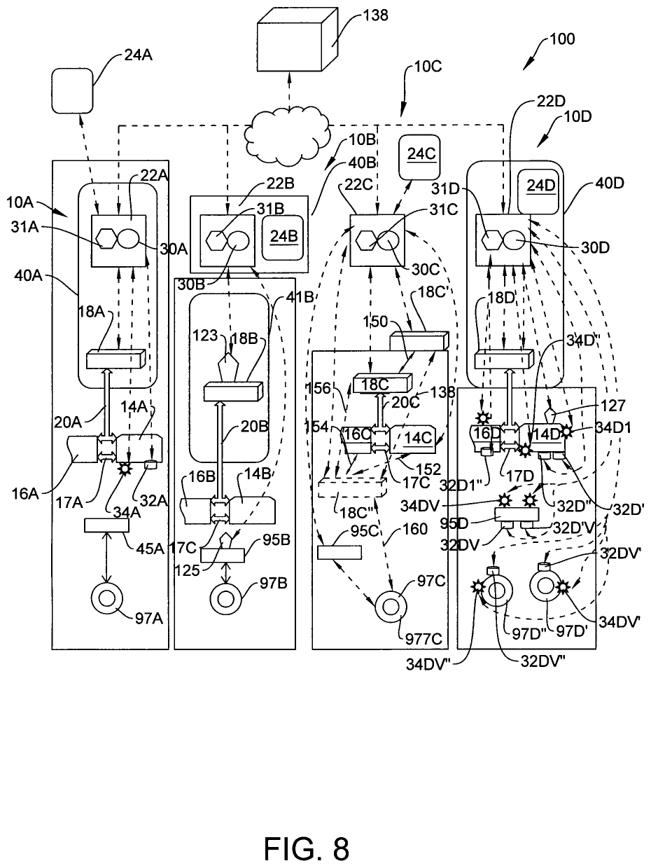

Turning now to FIG. 8, there is shown a system 100 including a plurality of devices 10A, 10B, 10C and 10D for providing additional electrical power to respective engine powered vehicles 12A, 12B, 12C, and 12D and for selectively monitoring and modulating components of the vehicles.

Each vehicle 12A, 12B, 12C, and 12D comprises respective vehicle batteries 14A, 14B, 14C, 14D and respective alternators 16A, 16B, 16C, 16D in respective mutual electrical communication 17A, 17B, 17C, 17D.

Each device 10A, 10B, 10C and 10D comprises respective auxiliary batteries 18A, 18B, 18C and 18D for being in electrical communication 20A, 20B, 20C and 20D, respectively with the vehicle battery 14A, 14B, 14C and 14D. In an embodiment, this electrical communication is provided by respective cables 20A, 20B, 20C and 20D. Thus, the auxiliary batteries 18A, 18B, 18C and 18D and the cables 20A, 20B, 20C and 20D are mounted to the vehicles 12A, 12B, 12C, and 12D, respectively. More particularly, batteries 18A, 18B, and 18C and cables 20A, 20B, and 20C are integrated within the vehicle 12A, 12A and 12C, whereas battery 18D is mounted externally to vehicle 12A and the cable 20D is connected to both the external battery 18D and the internal vehicle battery 14C. As previously mentioned, the cables 20A, 20B, 20C and 20D respectively provide for electrical communication between the auxiliary batteries 18A, 18B, 18C and 18D and the vehicle battery 14A, 14B, 14C, 14D of vehicles 12A, 12B, 12C, and 12D.

Device 10C is shown to comprise first and second additional auxiliary batteries 18C′ and 18C″. Of course, the device 10C can include one additional auxiliary battery or more than the two shown in this non-limiting example. In this example, battery 18C′ is positioned externally of the vehicle 12C and is in electrical communication 150 with battery 18C. In this example, battery 18C″ is positioned within the vehicle 12C and is provided to be in electrical communication 152 with battery 14C, and/or in electrical communication 154 with the alternator 16C, and/or in electrical communication 156 with the battery 18C and/or in electrical communication 158 the battery 18C″ and/or electrical communication 160 with another vehicle component 90C and any combination thereof.

Each auxiliary battery 18A, 18B, 18C and 18D is in operative communication with a respective controller 22A, 22B, 22C and 22D. The batteries 18C′ and 18C″ may also be selectively positioned in operative communication with the controller 22C in accordance with an embodiment of the present disclosure. Each controller 22A, 22B, 22C and 22D is in operative communication with a respective user interface 24A, 24B, 24C and 24D. Each controller 22A, 22B, 22C and 22D comprises a respective processor (or microprocessor) 31A, 31B, 31C, 31D with a respective associated memory 30A, 30B, 30C, 30D of processor executable code that when executed provide the controller of performing computer implementable steps of assessing a condition status of a respective auxiliary battery 18A, 18B, 18C, 18D and/or the vehicle battery 14A, 14B, 14C, 14D and for modulation thereof. The controller 22C is shown to be in operative communication with batteries 18C′ and 18C″.

A master controller 138 is in remote operative communication with controllers 22A, 22B, 22C and 22D via a network. The master controller 138 comprises a processor with an associated memory of processor executable code that when executed provides the master controller 138 to perform the computer implementable steps of receiving data from the controllers 22A, 22B, 22C and 22D, analyzing the data, communicating the data and/or analysis thereof via an interface in operative communication therewith, transmitting data to the controllers 22A, 22B, 22C and 22D for being communicated to users via the interfaces 24A, 24B, 24C, 24D and modulating e the controllers 22A, 22B, 22C and 22D in the performance of their computer implementable steps including steps for modulating other components as described herein.

Device 10A includes a housing 40A for the controller 22A and the battery 18A. The housing 40A is mounted directly within the vehicle 12A. Thus, controller 22A is mounted directly within vehicle 12A. Controller 22A is in operative communication with an external, remote and handheld user interface 24A for communicating data to users and for receiving user commands in order to execute processor executable code for providing the controller 22A to perform computer implementable steps. Vehicle 12A includes a computer 95A as well as one or more vehicle components 97A in communication therewith. In this example, there is no operative communication between controller 22A and the vehicle computer 95A or another vehicle component 97A. Controller 22A is also in communication with a sensor 32A in operative communication with the battery 14A in order to receive information related to the status thereof as well as with a supplemental instrument 34A also in operative communication with the batter 14A in order to provide additional modulation to the battery (heat etc.).

Device 10B includes a housing 40B for housing the controller 22B and an interface 40B. Interface 40B is similar to interface 40A, yet it is provided in a single integrated unit (which can be a mobile handheld unit) with the controller 22B. The housing 40B is thus not mounted to the vehicle 12B. Controller 22B communicates remotely with the auxiliary battery 18B via a processor 123 in operative communication therewith. Thus, controller 22B and processor 123 define a controller assembly. Controller 22B is in operative communication with the vehicle computer 95B via processor 125 in operative communication therewith. Thus, controller 22B and processor 125 define a controller assembly. The vehicle computer 95B is in operative communication with one or more vehicle components 97B. Accordingly the controller 22C can perform upon execution of the processor executable code the computer implementable steps of transmitting and/or receiving data from computer 95B, communicating data received form computer 95B to users via interface 24B, modulating computer 95B in order to modulate the computer implementable steps performed thereby as well as receiving data and/or modulating from component 97B in operative communication with computer 95B. Controller 22C communicates remotely with both the batteries 18C and the computer 95B.

Device 10C does not include a housing but is rather a complete assembly of communicating parts. Therefore, the controller 22C is in operative communication with the batteries 18C, 18C′, 18C″ and 14C and with the vehicle computer 95C which is also in operative communication with one or more vehicle components 97C. The controller 22C is not mounted to the vehicle 12C and is in communication with a remote interface 24C. For example, the controller 22C comprises a CPU in communication with a mobile device that acts as the interface 24C. The parts herein interact as described above.

Device 10D comprises a housing 40D for the controller 22D, the battery 18D and the interface 24D. The housing 40D is mounted to the vehicle 12 externally thereof. Controller 22D is operative communication with battery 14D via processor 127 in communication there with and with: sensors 32DI, 32DII in operative communication with the battery 14D, with sensor 32DIII in operative communication with the alternator 16D, with sensors 32DIV and 32DV in operative communication with the vehicle computer 95D, with sensors 32DVI and 32DVII in respective operative communication with vehicle components 97D′ and 97D″. The controller 22D thus receives a status condition of the item a given sensor communicates with. The status condition is communicated via the interface 24D. A condition may be modulated by the controller 22D automatically or by user modulation commands via the interface 24D. Moreover, the controller 22D may modulate automatically or via user commands a status condition by way of: supplemental instruments 34D1 and 34DII in operative communication with the battery 14D, supplemental instrument 34DII in communication with the alternator 16D, supplemental instruments 34DIV and 34DV in operative communication with computer 95D and supplemental instruments 34DVI and 34DVII in respective operative communication with vehicle components 97D′ and 97D″.

The above describe elements of the exemplary devices 10, 10A, 10B, 10C and 10D as well as systems 38 and 138 can be combined in various ways, with more or less elements in order to provide still more non-restrictive embodiments within the context of the present disclosure and as can be understood by the skilled artisan.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A device for providing additional electrical power to an engine powered vehicle comprising a vehicle battery and an alternator, the device comprising:
an auxiliary battery for being mounted to the vehicle to be maintained therewith during driving of the vehicle, the auxiliary battery being positioned and maintained in electrical communication with the vehicle battery during driving of the vehicle,
wherein the auxiliary battery provides for supplying additional electrical power for starting the engine when the vehicle battery is depleted and/or for recharging the vehicle battery to avoid depletion thereof.

2. A device according to claim 1, wherein the auxiliary battery is positioned within the vehicle and maintained within the vehicle.

3. A device according to any one of claim 1 or 2, further comprising a cable in electrical communication with the auxiliary battery for being positioned and maintained in electrical communication with the vehicle battery during driving of the vehicle to provide the electrical communication between the auxiliary battery and the vehicle batter.

4. A device according to claim 3, wherein the cable is positioned and maintained in electrical communication with the alternator to receive electrical power therefrom during driving of the vehicle for recharging thereof.

5. A device according to 3, wherein the cable is in electrical communication with the alternator via a ground connection.

6. A device according to claim 5, wherein the ground connection is provided by a removable fastener.

7. A device according to any one of claims 1 to 6, wherein the vehicle battery provides for replenishing the auxiliary battery with electrical power during driving of the vehicle.

8. A device according to any one of claims 3 to 5, wherein the cable is fastened to the vehicle battery.

9. A device according to any one of claims 1 to 6, further comprising a housing for housing the auxiliary battery therein.

10. A device according to claim 9, wherein the housing comprises a connector for providing electrical communication with the auxiliary battery.

11. A device according to any one of claim 9 or 10, wherein the housing comprises water-resistant material.

12. A device according to any one of claims 1 to 9, further comprising a heating element in communication with the auxiliary battery for heating thereof, a heating element controller in communication with the heating element for control thereof and an ambient temperature sensor for detecting the ambient temperature and being in communication with the heating element controller, the heating element controller providing for modulating the heating element to selectively provide heat to the auxiliary battery based on the detected ambient temperature.

13. A device according to any one of claims 1 to 12, further comprising:
a controller comprising a processor and an associated memory of processor executable code that when executed provides the controller to perform computer implementable steps, the controller being in communication with the auxiliary battery; and
a user interface in communication with the controller.

14. A device according to claim 13, wherein the controller is in operative communication with the auxiliary battery, the user interface providing a user to selectively modulate electrical power supply from the auxiliary battery via commands transmitted to the controller.

15. A device according to any one of claim 13 or 14, wherein the controller performs the computer implementable steps of:
identifying a real-time amount of electrical power stored in the auxiliary battery;
and communicating the real-time amount of electrical power stored to a user via the user interface.

16. A device according to claim 15, further comprising an auxiliary battery sensor in communication with the auxiliary battery and the controller for detecting the real-time amount of electrical power stored in the auxiliary battery and for transmitting the detected amount to the controller.

17. A device according to any one of claims 13 to 16, wherein the controller performs the computer implementable steps of:
identifying a condition status of the auxiliary battery; and
communicating the condition status of the auxiliary battery to the user via the user interface.

18. A device according to any one of claims 13 to 17, wherein the controller is positioned in and configured for operative communication with the vehicle battery.

19. A device according to 18, wherein the controller performs the computer implementable steps of:
identifying the amount of electrical power stored in the vehicle battery;
communicating the real-time amount of electrical power stored to a user via the user interface.

20. A device according to claim 19, further comprising a vehicle battery sensor in communication with the vehicle battery and the controller for detecting the real-time amount of electrical power stored in the vehicle battery and for transmitting the detected amount to the controller.

21. A device according to any one of claims 13 to 20, wherein the controller performs the computer implementable steps of:
identifying a condition status of the vehicle battery; and
communicating the condition status of the vehicle battery to the user via the user interface.

22. A device according to any one of claims 13 to 21, further comprising an ambient temperature sensor in communication with the controller for detecting the ambient temperature and transmitting the detected ambient temperature to the controller.

23. A device according to claim 20, further comprising a heating element in operational communication with the auxiliary battery for providing heating thereto and in operational communication with the controller, the controller performing the computer implementable step of:
modulating the heating element to selectively provide heat to the auxiliary battery based on the ambient temperature.

24. A device according to any one of claim 21 or 23, wherein the controller performs the computer implementable step of:
communicating the ambient temperature to the user via the user interface.

25. A device according to claim 22, further comprising a heating element in operational communication with the auxiliary battery for providing heating thereto and in operational communication with the controller, wherein the controller performs the computer implementable step of:
communicating the ambient temperature to the user via the user interface for providing the user to selectively modulate the heating element to selectively provide heat to the auxiliary battery via the controller by way of user commands.

26. A device according to any one of claims 11 to 23, further comprising an additional condition detecting instrument for detecting a pre-determined condition, the additional condition detecting instrument being in operational communication with the controller for providing thereto the detected condition.

27. A device in accordance with claim 26, wherein the controller communicates the detected condition to the user via the user interface.

28. A device according to any one of claims 22 to 27, wherein the additional condition detecting instrument is selected from the group consisting of a motion detector, a GPS, an ambient sound detector, a data input for a vehicle integrated computer, a moisture sensor and any combination thereof.

29. A device according to any one of claims 13 to 28, wherein the controller and user interface are integrated in a handheld mobile unit.

30. A device according to any one of claims 13 to 28, wherein the controller is positioned within the vehicle and the user interface being integrated into a remote device.

31. A device according to any one of claims 13 to 28, wherein the controller comprises an assembly, the assembly comprising a plurality of processors, one processor being positioned within the vehicle another processor being integrated into a remote device.

32. A device according to claim 31, wherein the user interface is integrated into the remote device.

33. A device according to claim 32, wherein the remote device comprises a handheld unit.

34. A device according to any one of claims 13 to 33, further comprising at least one supplemental instrument in operative communication with an element selected from the group consisting of: the auxiliary battery, the vehicle battery, the alternator, a vehicle computer, one or more vehicle components and any combination thereof.

35. A device according to claim 34, wherein the controller is in operative communication with the element and performs the computer implementable step of:
modulating the element in accordance with a status condition.

36. A system for monitoring and/or modulating a plurality of devices according to claims 13 to 35, wherein the system comprises:
a master controller in communication with the controller of each of the devices for receiving identified information therefrom; and
a system interface for communicating the identified information to a system user.

37. A method for providing additional electrical power to an engine powered vehicle comprising a vehicle battery and an alternator, the method comprising:
installing an auxiliary battery within the vehicle to be maintained therein during driving of the vehicle; and
providing electrical communication between the auxiliary battery and the vehicle battery during driving of the vehicle,
supplying additional electrical power from the auxiliary batter for starting the engine when the vehicle battery is depleted and/or for recharging the vehicle battery to avoid depletion.

38. A method according to claim 37, further comprising:
replenishing the auxiliary battery with electrical power from the alternator when driving the car and or from the vehicle batter when driving the car.

39. A method according to any one of claim 37 or 38, further comprising:
detecting a real-time condition status of the auxiliary battery and/or the vehicle and communicating the real-time condition to a remote user in real-time.

40. A method according to any one of claims 37 to 39, further comprising modulating heating of the auxiliary battery based on ambient temperature.
